(19) United States
(12) Patent Application Publication
(10) Pub. No.: US 2021/0063969 A1
(43) Pub. Date: Mar. 4, 2021

(54) ELECTRONIC WATCH

(71) Applicant: Seiko Epson Corporation, Tokyo (JP)

(72) Inventor: Yoshihide KANEKO, Shiojiri (JP)

(21) Appl. No.: 17/004,178

(22) Filed: Aug. 27, 2020

(30) Foreign Application Priority Data
Aug. 30, 2019 (JP) 2019-158132

(51) Int. Cl. G04B 19/23

(52) U.S. Cl. CPC G04B 19/235

(57) ABSTRACT

An electronic watch includes a time display unit that includes an hour hand fixed to a first pointer shaft and a minute hand fixed to a second pointer shaft coaxial with the first pointer shaft, the time display unit being configured to display a display time based on a reference time and a time difference information, a third pointer fixed to a third pointer shaft coaxial with the first pointer shaft, an operation device, and a controller that, in accordance with an operation of the operation device, executes a time difference correction mode that corrects the time difference information and causes the hour hand and the minute hand to display the display time in accordance with the corrected time difference information. In the time difference correction mode, the controller causes the third pointer to display other information different from the reference time and the time difference information.

The present application is based on, and claims priority from JP Application Serial Number 2019-158132, filed Aug. 30, 2019, the disclosure of which is hereby incorporated by reference herein in its entirety.

### BACKGROUND

### 1. Technical Field

The present invention relates to an electronic watch provided with a manually operated time difference correction function.

### 2. Related Art

JP-A-2015-102530 discloses an electronic watch that sets a time zone by moving, by a crown operation, a pointer that rotates around an axis disposed at a planar center of a dial, and designating a time zone display inscribed on a bezel or a dial ring. It is disclosed that, in the electronic watch, when the time zone is set by the crown operation, an internal time is corrected, and a local time is displayed by an hour hand and a minute hand.

With the electronic watch of JP-A-2015-102530, when manually setting the time zone by the crown operation, the three hands, namely, the hour hand, the minute hand, and the pointer that rotate around the axes disposed at the planar center of the dial are used, and information that can be displayed to the user during the time zone setting is limited.

### SUMMARY

An electronic watch according to an aspect of the present disclosure includes a storage unit configured to store time difference information, with the information relating to a time difference with respect to a reference time, a time display unit including a first pointer fixed to a first pointer shaft and a second pointer fixed to a second pointer shaft coaxial with the first pointer shaft, the time display unit being configured to display a display time based on the reference time and the time difference information, a third pointer fixed to a third pointer shaft coaxial with the first pointer shaft and the second pointer shaft, an operation device including a crown or a button, and a controller configured to, in accordance with an operation of the operation device, execute a time difference correction mode that corrects the time difference information, and causes the first pointer and the second pointer to display the display time in accordance with the corrected time difference information. The first pointer is an hour hand and the second pointer is a minute hand, and, in the time difference correction mode, the controller causes the third pointer to display other information different from the reference time and the time difference information.

In the electronic watch according to the aspect of the present disclosure, the electronic watch may include a receiver configured to receive radio wave. The controller may be configured to set a reception prohibiting mode that prohibits reception by the receiver, and the other information may be information indicating the setting of the reception prohibiting mode.

In the electronic watch according to the aspect of the present disclosure, the storage unit may store daylight saving time information relating to setting of a daylight saving time, the time display unit may display the display time based on the daylight saving time information, and the other information may be the daylight saving time information.

In the electronic watch according to the aspect of the present disclosure, the other information may be information relating to whether the display time in accordance with the corrected time difference information is before noon and after noon.

In the electronic watch according to the aspect of the present disclosure, when the time difference information is corrected in accordance with the operation of the operation device, the controller may move the first pointer and the second pointer to positions indicating the display time calculated based on the corrected time difference information and the reference time.

In the electronic watch according to the aspect of the present disclosure, the third guide may be a seconds hand.

In the electronic watch according to the aspect of the present disclosure, the operating device may include the crown configured to be pulled out to a plurality of stages, the controller may execute the time difference correction mode when the crown is pulled out to a first stage and when the crown is pulled out to a second stage, and the third pointer may display different information when the crown is pulled out to the first stage from information displayed when the crown is pulled out to the second stage.

In the electronic watch according to the aspect of the present disclosure, the controller may correct the time difference information in increments of a fixed time period, in accordance with the operation of the operation device.

### BRIEF DESCRIPTION OF THE DRAWINGS

FIG. 1 is a front view illustrating an electronic watch according to a first embodiment.

FIG. 2 is a block diagram illustrating a configuration of a movement according to the first embodiment.

FIG. 3 is a flowchart illustrating processing of a first time difference correction mode according to the first embodiment.

FIG. 4 is a flowchart illustrating first time difference correction processing according to the first embodiment.

FIG. 5 is a diagram illustrating an operation example of the first time difference correction mode according to the first embodiment.

FIG. 6 is a flowchart illustrating processing of a second time difference correction mode according to the first embodiment.

FIG. 7 is a flowchart illustrating second time correction processing according to the first embodiment.

FIG. 8 is a diagram illustrating an operation example of the second time difference correction mode according to the first embodiment.

FIG. 9 is a diagram illustrating an operation example of a received result display mode according to the first embodiment.

FIG. 10 is a diagram illustrating an operation example of a power reserve confirmation mode according to the first embodiment.

FIG. 11 is a flowchart illustrating processing of the first time difference correction mode according to a second embodiment.

FIG. 12 is a diagram illustrating an operation example of the first time difference correction mode according to the second embodiment.

FIG. 13 is a flowchart illustrating processing of a time difference correction mode according to a third embodiment.

FIG. 14 is a diagram illustrating an operation example of the time difference correction mode according to the third embodiment.

### DESCRIPTION OF EXEMPLARY EMBODIMENTS

Below, an electronic watch 1 according to embodiments will be described with reference to the drawings.

The electronic watch 1 is provided with a case 2, a dial 3 disposed in the case 2, an hour hand 4, a minute hand 5, and a seconds hand 6 that are respectively attached to three pointer shafts provided in a planar central position of the dial 3, a date indicator 7, a crown 8, an A button 9A, and a B button 9B.

Thus, in the electronic watch 1, a time display unit 41 that displays the time is configured to include the hour hand 4, the minute hand 5, the seconds hand 6, and the date indicator 7.

In the present embodiment, a first pointer is configured by the hour hand 4, a second pointer is configured by the minute hand 5, and a third pointer is configured by the seconds hand 6. Further, a first pointer shaft is configured by the pointer shaft (not illustrated) to which the hour hand 4 is attached, a second pointer shaft is configured by the pointer shaft (not illustrated) to which the minute hand 5 is attached, and a third pointer shaft is configured by the pointer shaft (not illustrated) to which the seconds hand 6 is attached. The first pointer shaft, the second pointer shaft, and the third pointer shaft are coaxial general pointer shafts provided at the planar center of the dial 3, and a description thereof will be omitted here.

Marks denoting information indicated by the seconds hand 6 are displayed on the dial 3. Note that a position of each of the marks will be described using an indication position on a seconds scale when the seconds hand 6 is indicating the mark.

On the dial 3, an airplane mark, which indicates that an airplane mode setting prohibiting reception of satellite signals is ON, is displayed at the 42 second position of the seconds hand 6. As described below, when the setting of the airplane mode is OFF, the seconds hand 6 indicates the 0 second position. Note that a mark indicating that the airplane mode is OFF is not inscribed at the 0 second position of the dial 3, but a mark indicating that the airplane mode is OFF may be inscribed.

On the dial 3, “Y” and “N” indicating YES and NO are respectively displayed at the 8 second position and the 52 second position of the seconds hand 6. “Y” and “N” are indicated when indicating a reception result success and a reception result failure, as described below.

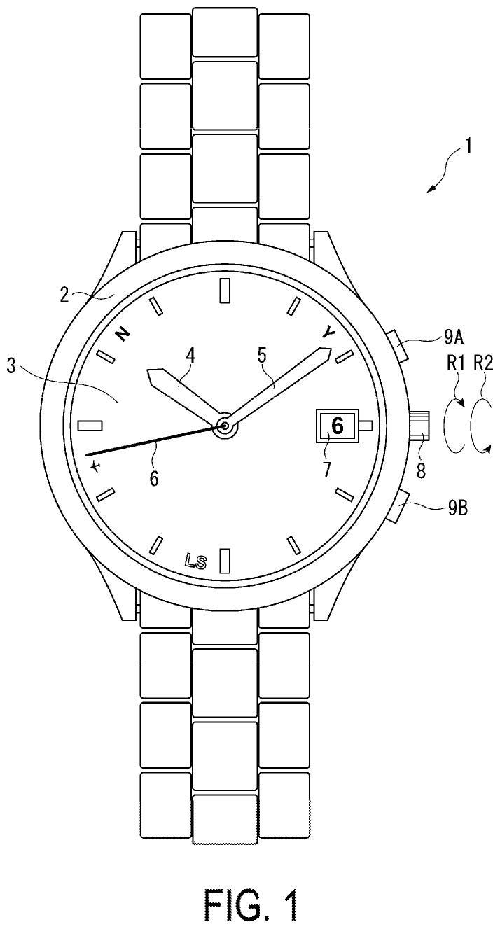

On the dial 3, a mark “LS”, which indicates information relating to the reception of a leap second, is displayed at the 32 second position of the seconds hand 6. Note that “LS” is indicated by the minute hand 5, as described below. Further, in the present embodiment, each of the marks is displayed on the dial 3, but each of the marks may be displayed on the bezel surface of the case 2. Further, when a dial ring is provided on the outer periphery of the dial 3, each of the marks may be displayed on the dial ring. Furthermore, the display position of each of the marks is not limited to the example in FIG. 1, and each of the marks may be displayed at a different position.

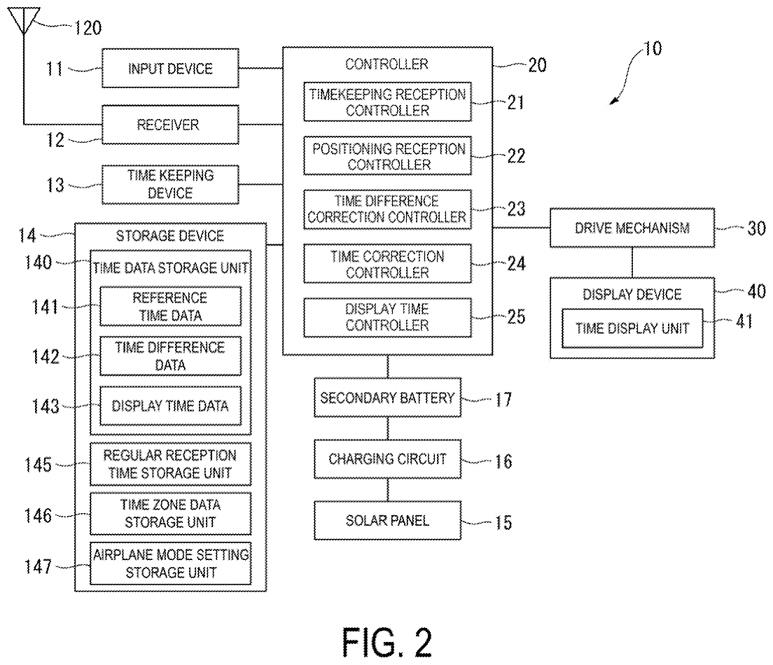

FIG. 2 illustrates a configuration of a movement 10 housed inside the case 2 of the electronic watch 1. The movement 10 includes an input device 11, a receiver 12, a time keeping device 13, a storage device 14, a solar panel 15, a charging circuit 16, a secondary battery 17, a controller 20, a drive mechanism 30, and a display device 40.

The input device 11 is configured to include the above-described crown 8, A button 9A, and B button 9B, and outputs a detection signal to the controller 20 when the crown 8, the A button 9A, and the B button 9B are operated.

Specifically, the input device 11 detects whether or not the crown 8 is pulled out to a position of a zero stage, a first stage or a second stage, detects a rotational direction and an amount of rotation of the crown 8, and pressing operations of the A button 9A and the B button 9B, and outputs these detection signals. Note that, in the present embodiment, the input device 11 determines that the crown 8 has been rotated by one step in a forward direction when the crown 8 has been rotated by 120 degrees in the rightward direction toward a 12 o'clock direction, namely, when the crown 8 has been rotated by 120 degrees in a first direction R1. Further, the input device 11 determines that the crown 8 has been rotated by one step in a reverse direction when the crown 8 has been rotated by 120 degrees in the leftward direction toward a 6 o'clock direction, namely, when the crown 8 has been rotated by 120 degrees in a second direction R2. Note that the angle at which it is determined that the crown 8 has been rotated by one step is not limited to 120 degrees, and may be set in accordance with a diameter of the crown 8 or the like.

In the present embodiment, an operation device including the crown 8 or the buttons 9A and 9B is configured by the input device 11.

The receiver 12 is coupled to an antenna 120, processes satellite signals received via the antenna 120, and acquires GPS time information and position information. It is sufficient that the antenna 120 be capable of receiving radio waves of satellite signals transmitted from a GPS satellite or a quasi-zenith satellite that orbits the skies above the Earth at a predetermined trajectory, and any antenna can be used as long as it can be built into the electronic watch 1, such as a patch antenna, a ring antenna, an inverted F antenna, or the like.

Although not illustrated in the drawings, the receiver 12 includes a radio frequency (RF) unit that receives a satellite signal transmitted from the GPS satellite or the quasi-zenith satellite and converts the received signal to a digital signal, a baseband (BB) unit that performs a correlation determination on the received signal and demodulates a navigation message, and an information acquisition unit that acquires and outputs the GPS time information and position information from the navigation message demodulated by the BB unit.

In the present embodiment, a receiver that receives radio waves is configured to include the receiver 12.

The time keeping device 13 includes a crystal oscillator that is driven by power accumulated in the secondary battery 17, and the like, and outputs a reference signal at 1 Hz based on an oscillation signal of the crystal oscillator.

The storage device 14 includes a time data storage unit 140, a regular reception time storage unit 145, a time zone data storage unit 146, and an airplane mode setting storage unit 147.

The time data storage unit 140 stores reference time data 141, time difference data 142, and display time data 143.

In the present embodiment, a storage unit that stores time difference information is configured by the storage device 14.

The reference time data 141 stores a coordinated universal time (UTC), which is the reference time of the present embodiment.

The time difference data 142 stores time difference information with respect to a coordinated universal time of the time displayed by the display device 40. For example, if the display device 40 displays a time of Japan, the time difference data 142 stores the time difference information of “+9 hours”.

The display time data 143 stores time information in which the time difference data 142 has been added to the reference time data 141.

Note that the electronic watch 1 according to the first embodiment is not provided with a function for setting daylight saving time. Thus, as described below, when switching the display time from a normal time to daylight saving time, the user may perform an operation to put forward the time difference by 1 hour, and when switching the display time from daylight saving time to the normal time, the user may perform an operation to put back the time difference by 1 hour.

The regular reception time storage unit 145 stores a time to perform automatic reception processing of a time measuring mode. When the display time data 143 becomes the time stored in the regular reception time storage unit 145, the controller 20 of the electronic watch 1 operates the timekeeping reception controller 21, and performs the automatic reception processing of the time measuring mode. In the time measuring mode, satellite signals are received from at least one satellite and are acquired. A regular reception time stored in the regular reception time storage unit 145 may be set by a manual operation by the user, or may be set to a time at which the previously performed automatic reception processing was successful.

The time zone data storage unit 146 stores time zone data in which position information based on latitude and longitude, and time difference information of an area identified by the position information are associated with each other. Thus, when current location information, which is the position information of a current location in a positioning mode, is acquired, the controller 20 can acquire the time difference information for the current location on the basis of the latitude and longitude of the current location information.

The airplane mode setting storage unit 147 stores airplane mode setting information. The airplane mode setting information is a flag of “1” or “0” indicating whether or not the airplane mode has been set, and “1” is set when the airplane mode is ON, and “0” is set when the airplane mode is OFF, for example. In the present embodiment, a reception prohibiting mode that prohibits reception processing by the receiver 12 is the airplane mode.

The solar panel 15 is a solar cell used for a watch. The charging circuit 16 supplies power generated by the solar panel 15 to the secondary battery 17, and charges the secondary battery 17. The secondary battery 17 is a power source for the movement 10.

The drive mechanism 30 is configured to include the hour hand 4, the minute hand 5, the seconds hand 6, a step motor (not illustrated) that drives the date indicator 7, a train wheel, a drive circuit, and the like.

The display device 40 is provided with the time display unit 41. The time display unit 41 is provided with the hour hand 4, the minute hand 5, the seconds hand 6, and the date indicator 7.

The controller 20 is configured by a watch IC that controls the electronic watch 1. A controller of the present embodiment is configured by the controller 20.

The controller 20 is provided with the timekeeping reception controller 21, a positioning reception controller 22, a time difference correction controller 23, a time correction controller 24, and a display time controller 25.

The timekeeping reception controller 21 performs reception processing in the time measuring mode, by operating the receiver 12 to locate at least one position information satellite, receive radio waves of satellite signals transmitted from the position information satellite, and acquire time information. In the present embodiment, the timekeeping reception controller 21 is configured to be capable of performing the reception processing in both automatic reception processing and manual reception processing. Examples of the automatic reception processing include regular automatic reception processing in which the reception processing is performed when the regular reception time stored in the regular reception time storage unit 145 is reached, and optical automatic reception processing in which the reception processing is performed when it can be determined that the solar panel 15 is being irradiated with sunlight outdoors. Note that when the airplane mode is ON, the timekeeping reception controller 21 does not perform the automatic reception processing nor the manual reception processing.

The positioning reception controller 22 performs the reception processing in the positioning mode by operating the receiver 12 to locate four or more position information satellites, receive radio waves of satellite signals transmitted from each of the position information satellites, and calculate and acquire the position information of the current location including latitude information and longitude information. Further, the positioning reception controller 22 can acquire the time information simultaneously when the satellite signal is received. In the present embodiment, the positioning reception controller 22 is configured to be capable of performing the reception processing in the manual reception processing. Note that when the airplane mode is ON, the positioning reception controller 22 does not perform the manual reception processing.

The time difference correction controller 23 updates the time difference data 142. Specifically, when the position information is successfully acquired by the positioning reception controller 22, the time difference information acquired from the time zone data storage unit 146 is stored in the time difference data 142 on the basis of the acquired latitude information and longitude information.

Further, the time difference correction controller 23 stores the selected time difference information in the time difference data 142 when the time difference information is set by operation of the input device 11.

When the time information is successfully acquired in the reception processing of the timekeeping reception controller 21 or the positioning reception controller 22, the time correction controller 24 adjusts the acquired time information using leap second information included in the satellite signal and calculates the coordinated universal time, and updates the reference time data 141 using the coordinated universal time. Once the leap second information is successfully received, that value can be stored and used. Further, the leap second information can be updated by being received by the timekeeping reception controller 21 during a predetermined time period. Further, the time correction controller 24 updates the reference time data 141 using the 1 Hz reference signal output from the time keeping device 13.

In conjunction with updating the reference time data 141, the time correction controller 24 also updates the display time data 143 using the time data 142.

The display time controller 25 controls the drive mechanism 30 in conjunction with updating the display time data 143, and updates the display of the time display unit 41 of the display device 40.

First Time Difference Correction Mode

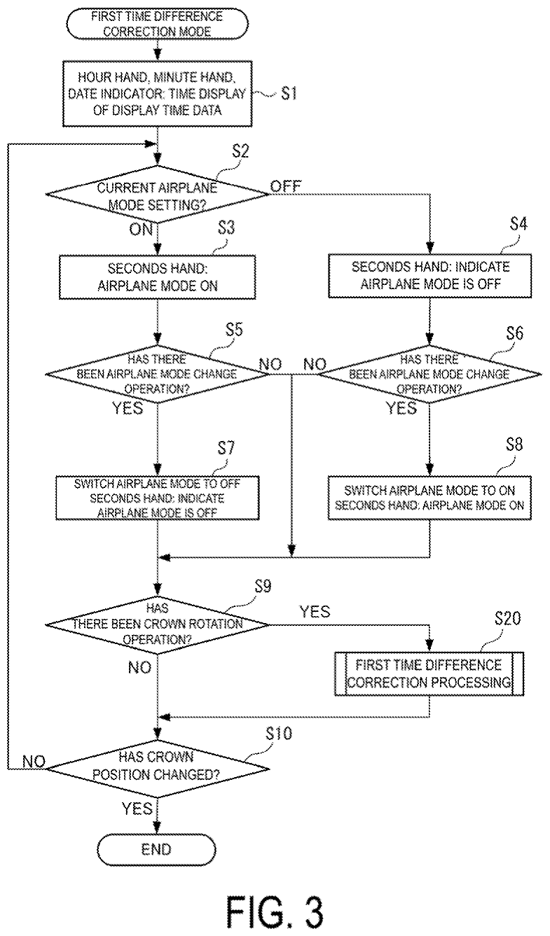

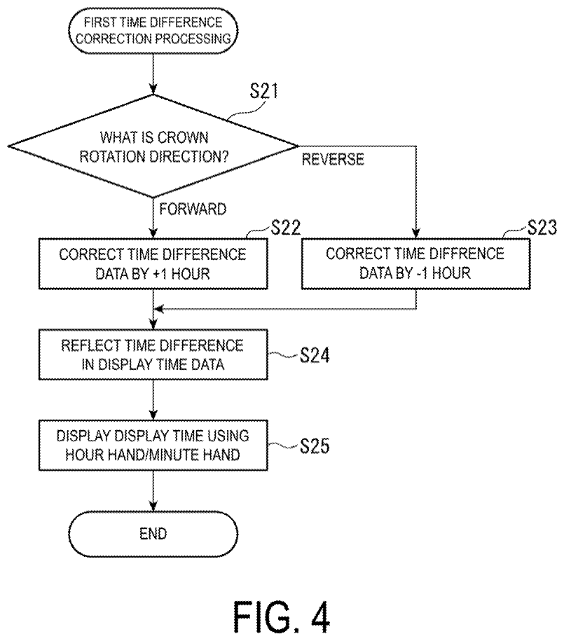

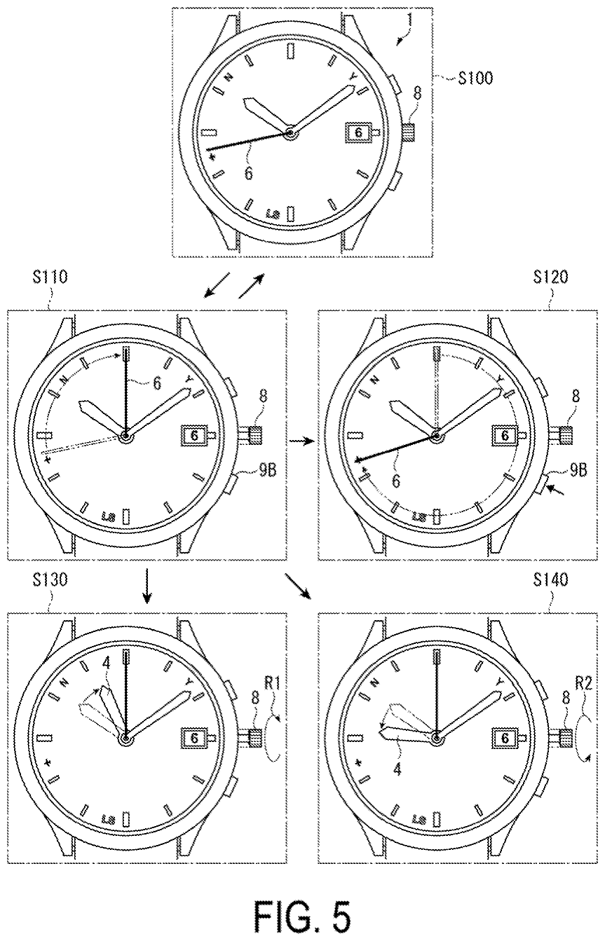

Next, operations when the crown 8 is pulled out by one stage and a first time difference correction mode is executed will be described with reference to flowcharts in FIG. 3 and FIG. 4, and an operation explanatory diagram in FIG. 5.

When the crown 8 is pulled out by one stage, step S1 is performed in which the display time controller 25 of the controller 20 controls the drive mechanism 30, and the hour hand 4, the minute hand 5, and the date indicator 7 continue to display the time of the display time data 143, namely, a current time.

Next, the controller 20 performs step S2 in which the controller 20 refers to the airplane mode setting storage 147, and verifies a current airplane mode setting. When it is determined, at step S2, that the setting of the airplane mode is ON, the controller 20 performs step S3 in which, via the display time controller 25, it is indicated by the seconds hand 6 that the airplane mode is ON. When step S3 is performed, the display time controller 25 moves and stops the seconds hand 6 at a position indicating the airplane mark inscribed on the dial 3, that is, at the 42 second position.

On the other hand, when it is determined, at step S2, that the airplane mode is OFF, the controller 20 performs step S4 in which, via the display time controller 25, it is indicated by the seconds hand 6 that the airplane mode is OFF. When step S4 is performed, the display time controller 25 moves and stops the seconds hand 6 at a position indicating that the airplane mode is OFF, that is, at the 0 second position.

For example, as illustrated in S100 in FIG. 5, when an operation is performed to pull out the crown 8 from the zero stage to the first stage, from a state in which the crown 8 is at the zero stage that is a reference position and the hour hand 4, the minute hand 5, the seconds hand 6, and the date indicator 7 are displaying the normal time, the controller 20 indicates the setting of the airplane mode by moving the seconds hand 6. S110 in FIG. 5 is an example in which the seconds hand 6 is moved to the position indicating that the airplane mode is OFF, that is, to the 0 second position. When the seconds hand 6 is indicating the setting of the airplane mode, the hour hand 4, the minute hand 5, and the date indicator 7 continue to display the time of the display time data 143, namely, the current time.

Here, when an operation to push in the crown 8 from the first stage to the zero stage is performed, the hour hand 4, the minute hand 5, the seconds hand 6, and the date indicator 7 return to a state in which the normal time is displayed, as illustrated in S100 in FIG. 5.

The controller 20 performs steps S5 and S6 and determines whether or not an airplane mode change operation has been performed in a state in which the crown 8 is pulled out to the first stage and the seconds hand 6 is indicating the setting of the airplane mode. In the present embodiment, the airplane mode change operation is performed by pressing the B button 9B for three seconds or longer.

When the controller 20 determines YES at step S5, this means that the change operation has been performed in a state in which the airplane mode is ON, and thus, the controller 20 performs step S7 in which the controller 20 switches the airplane mode to OFF, and moves the seconds hand 6 in the clockwise direction from the 42 second position that is the airplane mode ON position to the 0 second position that is the airplane mode OFF position.

On the other hand, when the controller 20 determines YES at step S6, this means that the change operation has been performed in a state in which the airplane mode is OFF, and thus, the controller 20 performs step S8 in which the controller 20 switches the airplane mode to ON, and moves the seconds hand 6 in the clockwise direction from the 0 second position that is the airplane mode OFF position to the 42 second position that is the airplane mode ON position, as illustrated in S120 in FIG. 5.

After performing the processing at step S7 or step S8, or, alternatively, when NO is determined at step S5 or step S6, the time difference correction controller 23 of the controller 20 performs step S9 in which it is determined whether or not there has been a rotation operation of the crown 8. At step S9, using a detection result of the input device 11, the time difference correction controller 23 determines whether there has been a forward or reverse rotation of the crown 8 or whether there has been no operation.

When the time difference correction controller 23 determines YES at step S9, the time difference correction controller 23 performs first time difference correction processing at step S20 to be described later.

When the time difference correction controller 23 determines NO at step S9, the controller 20 performs step S10 and determines whether the position of the crown 8 has been changed, that is, whether the crown 8 has moved from the first stage to the zero stage or to the second stage.

When the controller 20 determines NO at step S10, the controller 20 returns to step S2 and continues the processing.

Next, the first time difference correction processing at step S20 will be described with reference to the flowchart in FIG. 4 and the operation explanatory diagram in FIG. 5.

When performing the first time difference correction processing, the time difference correction controller 23 performs step S21 and determines a rotational direction of the crown 8. If the time difference correction controller 23 determines, at step S21, that the crown 8 has been rotated forward by one step, the time difference correction controller 23 performs step S22 and corrects the time difference data 142 stored in the storage device 14 by +1 hour.

Further, if the time difference correction controller 23 determines, at step S21, that the crown 8 has been rotated in reverse by one step, the time difference correction controller 23 performs step S23 and corrects the time difference data 142 stored in the storage device 14 by −1 hour.

Note that, as described above, when switching the normal time to daylight saving time, it is sufficient that the time difference data 142 be corrected by +1 hour by rotating the crown 8 in the forward direction by one step. Further, when switching daylight saving time to the normal time, it is sufficient that the time difference data 142 be corrected by −1 hour by rotating the crown 8 in the reverse direction by one step.

Next, the time correction controller 24 performs step S24 in which the updated time difference data 142 is added to the reference time data 141 stored in the storage device 14 to reflect the time difference in the display time data 143.

Thus, after performing step S22, 1 hour is added to the display time data 143, and after performing step S23, minus 1 hour is added, that is, 1 hour is subtracted from the display time data 143.

Next, the display time controller 25 performs step S25, and displays the display time data 143 with the hour hand 4 and the minute hand 5. During this time, the seconds hand 6 is stopped at the position indicating the airplane mode. Thus, the display time controller 25 outputs, to the drive mechanism 30, a drive signal to move the hour hand 4 by +1 hour, or a drive signal to move the hour hand 4 by −1 hour.

For example, as illustrated in S110 in FIG. 5, if the current time before the time difference is reflected is 8 minutes and 43 seconds past 10 o'clock, the current time after reflecting the +1 hour time difference is 8 minutes and 43 seconds past 11 o'clock, and the current time after reflecting the −1 hour time difference is 8 minutes and 43 seconds past 9 o'clock, as illustrated in S140 in FIG. 5. At this time, the seconds hand 6 continues to indicate the setting of the airplane mode. For example, if the airplane mode is set to OFF, the seconds hand 6 is stopped in the state indicating the 0 second position, as illustrated in S130 and S140 in FIG. 5. Further, although not illustrated, if the airplane mode is set to ON, the seconds hand 6 is stopped in the state indicating the 42 second position.

When the first time difference correction processing at step S20 ends, the controller 20 returns to step S10 in FIG. 3 and continues the processing. Thus, when the rotation operation of the crown 8 continues, the hour hand 4 is moved in increments of +1 hour or −1 hour, while continuing a normal hand operation. The minute hand 5 continues the normal hand operation. When, in order to display the state of the airplane mode, the seconds hand 6 is moved to either the 42 second position or the 0 second position and is stopped, and the operation of pressing the B button 9B for three seconds or longer to switch the airplane mode is performed, the seconds hand 6 moves to the position indicating the airplane mode to which the mode has been switched.

When the controller 20 determines YES at step S10, the controller 20 ends the processing of the first time difference correction mode, and when the crown 8 is pushed in to the zero stage, the hour hand 4, the minute hand 5, the seconds hand 6, and the date indicator 7 perform normal time display. At this time, when the time difference data 142 is changed, the time difference is reflected in the display time data 143, and the time reflecting the time difference is indicated by the hour hand 4 and the minute hand 5. Further, when the airplane mode is set to ON, the receiver 12 is stopped and the state of prohibiting the reception processing of the satellite signals is maintained.

Second Time Difference Correction Mode

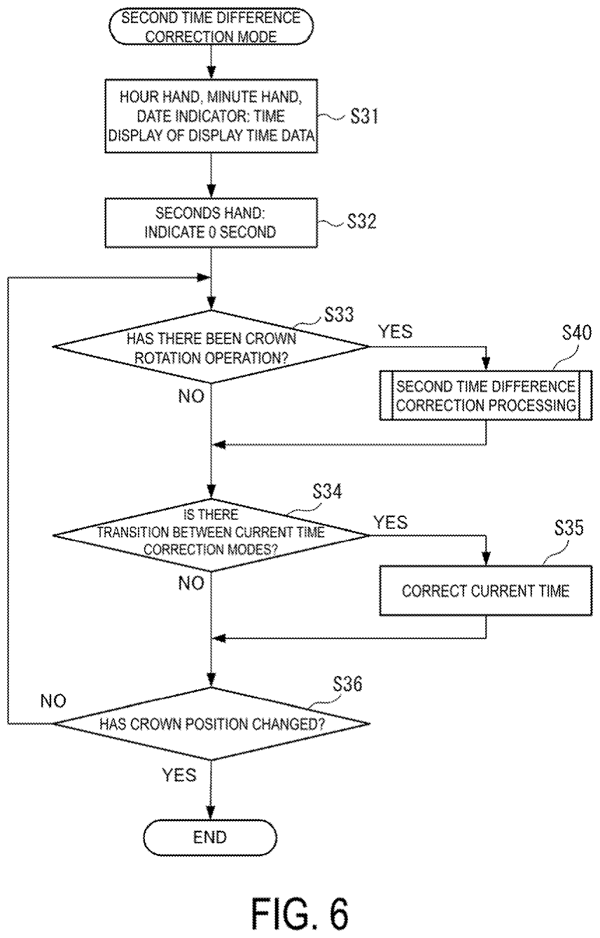

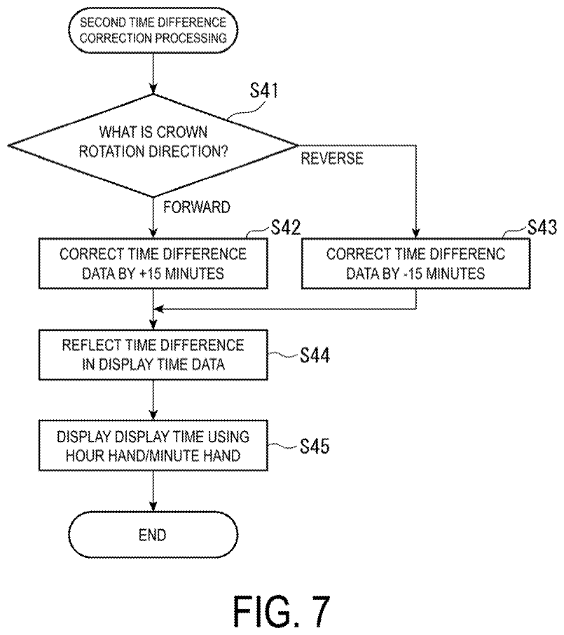

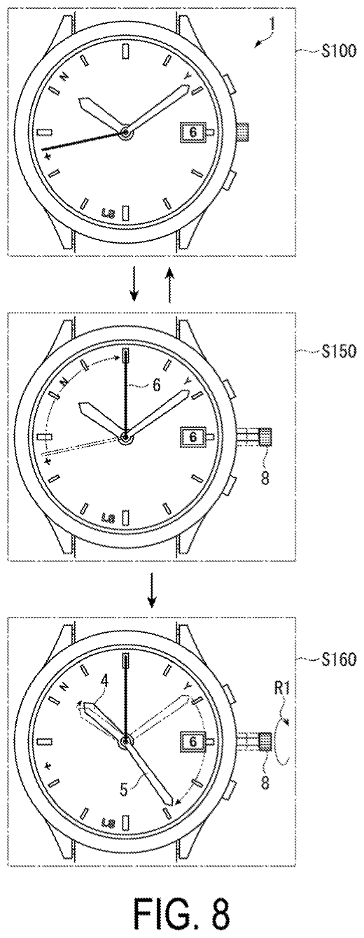

Next, a second time difference correction mode executed when the crown 8 is pulled out to the second stage will be described using flowcharts in FIG. 6 and FIG. 7, and an operation explanatory diagram in FIG. 8.

From the display state of the normal time illustrated in S100 in FIG. 8, when the crown 8 is pulled out by two stages, step S31 is performed in which the display time controller 25 of the controller 20 controls the drive mechanism 30, and the hour hand 4, the minute hand 5, and the date indicator 7 continue to display the time of the display time data 143, namely, the current time.

Further, as illustrated in S150 in FIG. 8, the display time controller 25 performs step S32 and moves the seconds hand 6 to the 0 second position and stops the seconds hand 6.

In other words, whereas, in the first time difference correction mode, the seconds hand 6 indicates the setting of the airplane mode, in the second time difference correction mode, the seconds hand 6 does not indicate any special information and is stopped at the 0 second position in order to indicate that this is the time difference correction mode that is different from a normal hand operation mode.

After the processing at step S32 is performed, the time difference correction controller 23 of the controller 20 performs step S33 and determines whether or not there has been a rotation operation of the crown 8. If the time difference correction controller 23 determines YES at step S33, second time difference correction processing at step S40 to be described later is performed.

When the controller 20 determines NO at step S33, and after the second time difference correction processing at step S40 is performed, the controller 20 performs step S34 and determines whether or not there has been a transition operation to a current time correction mode. In the present embodiment, when the B button 9B is pressed for six seconds or longer while the crown 8 is pulled out to the second stage, the current time correction mode at step S35 is executed.

When the current time correction mode is executed, the time correction controller 24 of the controller 20 detects the rotation operation of the crown 8 and corrects the current time in accordance with the rotation operation. Specifically, the time correction controller 24 controls the drive mechanism 30, and advances the reference time data 141 by 1 minute when the crown 8 is rotated by one step in the forward direction, and puts back the reference time data 141 by 1 minute when the crown is rotated by one step in the reverse direction. In this way, the display time data 143 is updated, and the time indicated by the hour hand 4 and the minute hand 5 is also updated.

Further, when the rotation operation of the crown 8 is performed rapidly in the forward direction or the reverse direction, the time correction controller 24 updates the reference time data 141 at a predetermined speed, the display time data 143 is updated in conjunction, and the hour hand 4 and the minute hand 5 move rapidly. This rapid movement is stopped by once more operating the crown 8 or by pressing the A button 9A, or the B button 9B.

When the controller 20 determines NO at step S34, and when the current time correction processing at step S35 ends, the controller 20 performs step S36 and determines whether the position of the crown 8 has been changed, that is, whether or not the crown 8 has been moved from the second stage to the zero stage or the first stage.

When the controller 20 determines NO at step S36, the controller 20 returns to step S33 and continues the processing.

Second Time Difference Correction Processing

Next, the second time difference correction processing at step S40 will be described with reference to the flowchart in FIG. 7 and the operation explanatory diagram in FIG. 8.

When performing the second time difference correction processing, the time difference correction controller 23 performs step S41 and determines the rotational direction of the crown 8. If the time difference correction controller 23 determines, at step S41, that the crown 8 has been rotated forward by one step, the time difference correction controller 23 performs step S42 and corrects the time difference data 142 stored in the storage device 14 by +15 minutes.

Further, if the time difference correction controller 23 determines, at step S41, that the crown 8 has been rotated in reverse by one step, the time difference correction controller 23 performs step S43 and corrects the time difference data 142 stored in the storage device 14 by −15 minutes.

Next, the time correction controller 24 adds the updated time difference data 142 to the reference time data 141 stored in the storage device 14 to reflect the time difference in the display time data 143.

Thus, after performing step S42, 15 minutes is added to the display time data 143, and after performing step S23, minus 15 minutes is added, that is, 15 minutes is subtracted from the display time data 143.

Next, the display time controller 25 performs step S45, and displays the display time data 143 with the hour hand 4 and the minute hand 5. During this time, the seconds hand 6 is stopped at the position indicating 0 seconds. In other words, the display time controller 25 outputs, to the drive mechanism 30, a drive signal to move the minute hand 5 by +15 minutes or a drive signal to move the minute hand 5 by −15 minutes.

For example, if the current time before the time difference is reflected is 8 minutes past 10 o'clock, as illustrated in S150 in FIG. 8, the current time after reflecting the +15 minute time difference is 23 minutes past 10 o'clock, as illustrated in S160 in FIG. 8, and, although not illustrated, the current time after reflecting the −15 minute time difference is 53 seconds past 9 o'clock.

In this way, once the second time difference correction processing at step S40 ends, the processing returns to step S34 in FIG. 6 and the processing is continued. Thus, as the rotation operation of the crown 8 continues, the hour hand 4 and the minute hand 5 are moved in increments of +15 minutes or −15 minutes, while continuing the normal hand operation. Further, the seconds hand 6 is maintained in the state of having been moved to and stopped at the 0 second position.

When the controller 20 determines YES at step S36, the second time difference correction mode is ended, and when the crown 8 is pushed in to the zero stage, the hour hand 4, the minute hand 5, the seconds hand 6, and the date indicator 7 perform the normal time display. At this time, when the time difference data 142 is changed, the time difference is reflected in the display time data 143, and the time reflecting the time difference is indicated by the hour hand 4 and the minute hand 5.

In addition to the first time difference correction mode and the second time difference correction mode described above, the electronic watch 1 according to the present embodiment has a reception result display mode that displays a reception result, and a power reserve confirmation mode that displays a battery residual capacity level. Hereinafter, operations of the pointers in the reception result display mode and the power reserve confirmation mode will be described.

Reception Result Display Mode

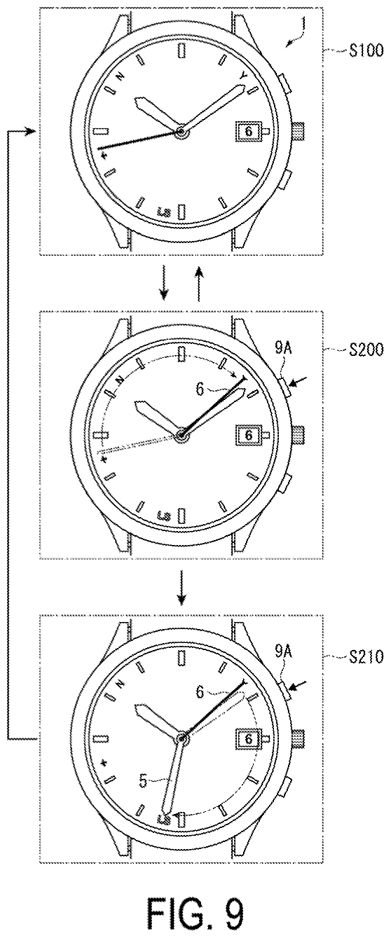

As illustrated in FIG. 9, when the input device 11 detects that the A button 9A has been pressed and released in a normal hand operation state illustrated in S100, that is, when the input device 11 detects that the A button 9A has been pressed for a short time of less than 3 seconds, the controller 20 executes the reception result display mode in which the reception result is displayed by the seconds hand 6.

If the immediately preceding reception result is successful, the controller 20 moves the seconds hand 6 to a position indicating reception success, specifically, to the 8 second position at which “Y” is inscribed, as illustrated in S200 in FIG. 9. Further, if the immediately preceding reception result fails, although not illustrated, the controller 20 moves the seconds hand 6 to a position indicating reception failure, specifically, the 52 second position at which “N” is inscribed.

After the movement of the seconds hand 6, if the B button 9B is pressed, or if 5 seconds has passed without either of the buttons 9A and 9B being pressed, the controller 20 returns to the normal hand operation state illustrated in S100.

After the display of the reception result by the movement of the seconds hand 6, if the A button 9A is once more pressed, the controller 20 moves the minute hand 5 to the position indicating “LS”, specifically to the 32 minute position, as illustrated in S210 in FIG. 9, and moves the seconds hand 6 to the “Y” or the “N” position in response to the reception result of the immediately preceding leap second. The minute hand 5 indicating “LS” indicates that the reception result indicated by the seconds hand 6 is the result of the reception of the immediately preceding leap second.

After the display of the reception result of the leap second also, if the B button 9B is pressed, or if 5 seconds has passed without either of the buttons 9A and 9B being pressed, the controller 20 returns to the normal hand operation state illustrated in S100.

Power Reserve Confirmation Mode

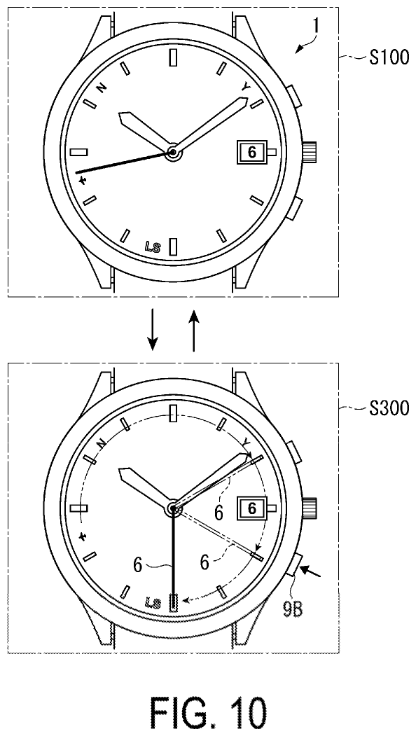

As illustrated in FIG. 10, when the input device 11 detects that the B button 9B has been pressed and released in the normal hand operation state illustrated in S100, that is, when the input device 11 detects that the B button 9B has been pressed for a short time of less than 3 seconds, the controller 20 executes the power reserve confirmation mode in which the battery residual capacity is displayed by the seconds hand 6.

In the power reserve confirmation mode, the controller 20 displays the battery residual capacity in three stages, namely, F (Full), M (Middle), and E (Empty). In other words, the controller 20 measures a voltage of the secondary battery 17, and if the voltage is greater than or equal to a first threshold, the controller 20 determines that the battery residual capacity is F, and moves the seconds hand 6 to the 30 second position, as illustrated in S300 in FIG. 10. If the voltage of the secondary battery 17 is less than a second threshold that is smaller than the first threshold, the controller 20 determines that the battery residual capacity is E, and moves the seconds hand 6 to the 10 second position If the voltage of the secondary battery 17 is less than the first threshold and greater than or equal to the second threshold, the controller 20 determines that the battery residual capacity is M, and moves the seconds hand 6 to the 20 second position.

After the display of the battery residual capacity by the movement of the seconds hand 6, if the B button 9B is pressed, or if 5 seconds has passed without either of the buttons 9A and 9B being pressed, the controller 20 returns to the normal hand operation state illustrated in S100.

Note that, during the execution of the reception result display mode and the power reserve confirmation mode, the pointers that are not used in the information display continue to display the current time.

### Effects of First Embodiment

According to the first embodiment, in the first time difference correction mode, when the crown 8 is pulled out to the first stage and rotated forward or in reverse, the time difference can be advanced or put back in increments of 1 hour, and the hour hand 4 and the minute hand 5 can be moved in conjunction with the rotation operation of the crown 8 and can display the time after the time difference correction. Thus, even if the seconds hand 6 does not indicate time difference information, the user can easily correct the time to that of the desired time zone.

Since the pointers used during the first time difference correction mode can be limited to the two pointers of the hour hand 4 and the minute hand 5, the seconds hand 6 can be used in the display of other information. Thus, the other information can be displayed to the user during the execution of the time difference correction mode, such as setting information of the airplane mode, for example. Thus, even with a dress watch of a simple design including only the three pointers of the hour hand 4, the minute hand 5, and the seconds hand 6 as the pointers, a plurality of pieces of information, that is, the two pieces of information of the time display after the time difference correction, and the setting information of the airplane mode, can be displayed, and it is possible to provide the electronic watch 1 having excellent design and convenience.

In addition to the first time difference correction mode that corrects the time difference in increments of 1 hour, the second time difference correction mode is also provided that corrects the time difference in increments of 15 minutes. Thus, it is possible to easily perform correction to a time zone having a time difference not only in units of 1 hour with respect to coordinated universal time, but in units of 30 minutes or 15 minutes. Therefore, currently, it is possible to correct the time to time zones adopted by all countries. Further, by combining the first time difference correction mode and the second time difference correction mode, the time difference can be set with a minimum amount of operation.

Furthermore, since the time difference correction amount in relation to the correction operation of the crown 8 is consistent with a pulled out position of the crown 8, and the setting operation of the time difference is consistent with the rotation operation of the crown 8 in the forward and reverse directions, the user can intuitively set the time difference, and operability can be improved.

In the first time difference correction mode, the value of the time difference is added by a constant time period, such as in increments of 1 hour, with respect to the time difference correction operation performed by rotating the crown 8, and thus, the user can intuitively correct the time difference without checking the display of the time display unit 41, and operability can be improved. For example, when advancing the time by 3 hours from the currently displayed time, it is sufficient to perform the correction operation of the crown 8 by 3 steps in the forward direction, and thus the intuitive operation is possible.

Rather than directly correcting the current time stored in the display time data 143, the time difference information stored in the time difference data 142 is corrected, and thus, the displayed time can be easily corrected to the time corresponding to the time zone of each country. Further, when performing the time difference correction operation crossing the date-line, the date indicator 7 can also be automatically moved and the displayed date can be automatically corrected, and thus, operability can be improved in comparison to a case in which the date indicator 7 is manually moved.

### Second Embodiment

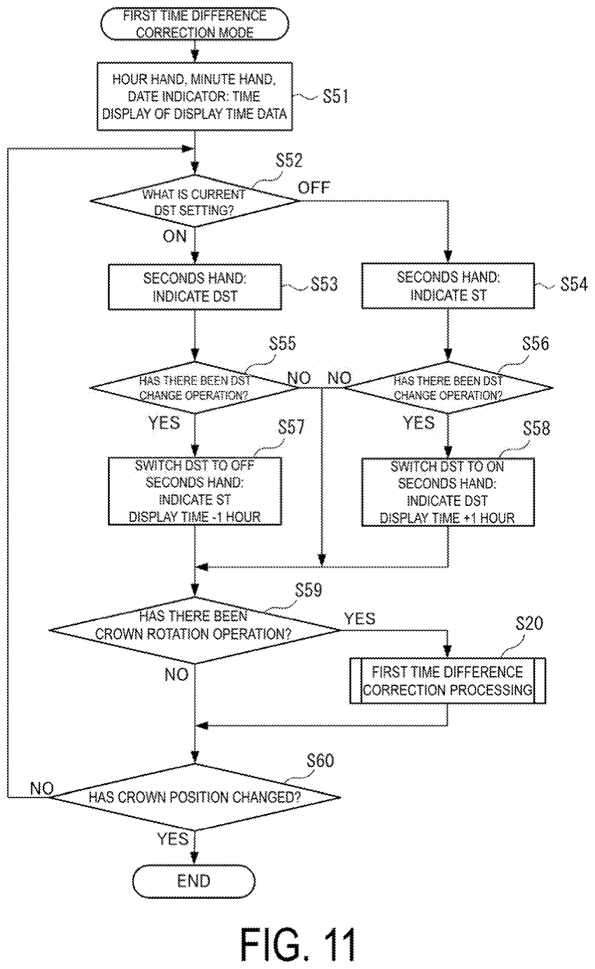

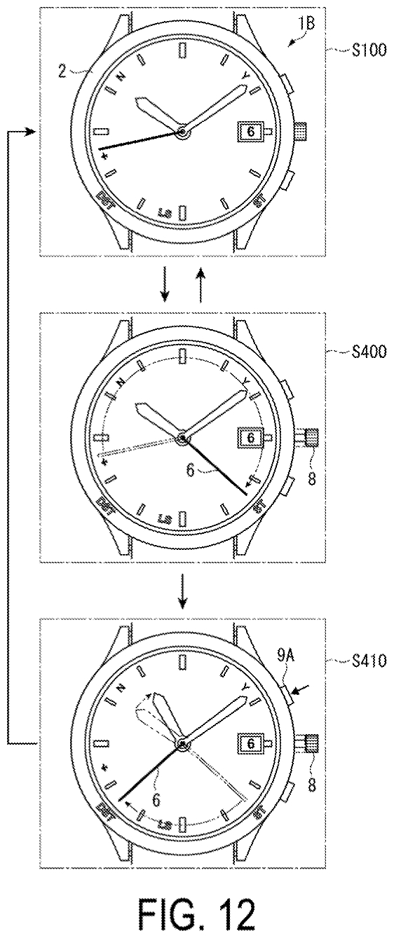

Next, an electronic watch 1B according to a second embodiment will be described using a flowchart in FIG. 11 and an operation explanatory diagram in FIG. 12. The internal configuration of the electronic watch 1B is substantially the same as that of the electronic watch 1 according to the first embodiment illustrated in FIG. 2, and a description thereof is thus omitted here.

However, since the electronic watch 1B is provided with a function to switch a daylight saving time setting, although not illustrated, the time data storage unit 140 of the storage device 14 stores daylight saving time setting data, in addition to the reference time data 141, the time difference data 142, and the display time data 143. The daylight saving time setting data is daylight saving time information relating to the setting of daylight saving time, and is a flag of “1” and “0” indicating the setting of daylight saving time, for example.

In the electronic watch 1B, when the daylight saving time setting data has the setting of “1”, that is, there is the daylight saving time setting, with respect to the reference time data 141 to which the value of the time difference data 142 has been added, 1 hour is further added to the display time data 143 as the daylight saving time setting.

In the electronic watch 1B, when the daylight saving time setting data has the setting of “0”, that is, there is no daylight saving time setting, the display time data 143 is a value obtained by adding the time difference data 142 to the reference time data 141. Thus, as described below, when switching from the daylight saving time setting to the no daylight saving time setting through manual operation by the user, 1 hour is subtracted from the display time data 143.

As illustrated in FIG. 12, the marks on the dial 3 of the electronic watch 1B are the same as those of the electronic watch 1. On the other hand, the electronic watch 1B is inscribed with “DST” and “ST” marks, which are not inscribed on the electronic watch 1. In other words, on the case 2 of the electronic watch 1B, the mark “DST” is displayed at the 38 second position of the seconds hand 6, indicating that the electronic watch 1B is set to daylight saving time, and the mark “ST” is displayed at the 22 second position of the seconds hand 6, indicating that the electronic watch 1B is not set to daylight saving time. In the following description, daylight saving time is also referred to as DST.

First Time Difference Correction Mode

In the electronic watch 1B, when the crown 8 is pulled out to the first stage, in a similar manner to the first embodiment, the first time difference correction mode is executed to correct the time difference in increments of 1 hour, and the display time controller 25 of the controller 20 controls the drive mechanism 30, and performs step S51 in which the hour hand 4, the minute hand 5, and the date indicator 7 continue to display the time of the display time data 143, that is, the current time.

Next, the controller 20 performs step S52, and confirms a current DST setting by referring to daylight saving time setting data. When the controller 20 determines, at step S52, that the DST is ON, that is, that the daylight saving time setting is “YES”, the controller 20 performs step S53 that indicates that the DST is ON, using the seconds hand 6. When step S53 is performed, the display time controller 25 moves and stops the seconds hand 6 to the position indicating the mark “DST” inscribed on the case 2, that is, the 38 second position.

On the other hand, when the controller 20 determines, at step S52, that the DST is OFF, that is, that the daylight saving time setting is “NO”, the controller 20 performs step S54 that indicates that the DST is OFF, using the seconds hand 6. When step S54 is performed, the display time controller 25 moves and stops the seconds hand 6 to the position indicating the mark “ST” inscribed on the case 2, that is, the 22 second position.

The controller 20 performs steps S55 and S56 to determine whether or not a DST change operation has been performed in a state in which the crown 8 is pulled out to the first stage and the seconds hand 6 is indicating the DST setting. In the present embodiment, the DST change operation is performed by pressing the A button 9A for three seconds or longer.

When the controller 20 determines YES at step S55, the controller 20 performs step S57 in which the controller 20 switches the DST to OFF, and moves the seconds hand 6 in the clockwise direction or the counterclockwise direction from the 38 second position indicating that the DST is ON, to the 22 second position indicating that the DST is OFF.

On the other hand, when the controller 20 determines YES at step S56, the controller 20 performs step S58 in which the controller 20 switches the DST to ON, and moves the seconds hand 6 in the clockwise direction from the 22 second indicating that the DST is OFF, to the 38 second position indicating that the DST is ON.

For example, when the operation is performed to pull out the crown 8 from the zero stage to the first stage, from a state in which the DST is set to OFF, the crown 8 is positioned at the zero stage, and the hour hand 4, the minute hand 5, the seconds hand 6, and the date indicator 7 display the normal time, as illustrated in S100 in FIG. 12, the seconds hand 6 moves to the 22 second position at which the “ST” mark is inscribed, as illustrated in S400 in FIG. 12.

Here, when the DST change operation is performed, as illustrated in S410 in FIG. 12, the seconds hand 6 moves to the 38 second position at which the “DST” mark is inscribed. Also, the daylight saving time setting data is changed to “1”, 1 hour is added to the display time data 143, and the hour hand 4 is advanced by 1 hour.

When switching these DST settings, the hour hand 4, the minute hand 5, and the date indicator 7 continue the normal hand operation.

Then, when the operation to push in the crown 8 from the first stage to the zero stage is performed, the hour hand 4, the minute hand 5, the seconds hand 6, and the date indicator 7 return to the state in which the normal time is displayed, as illustrated in S100 in FIG. 12.

In a similar manner to the first embodiment, after performing the processing at step S57 or step S58, or when NO is determined at step S55 or step S56, the time difference correction controller 23 of the controller 20 performs step S59 and determines whether or not there has been a rotation operation of the crown 8. When YES is determined at step S59, the first time difference correction processing at step S20 is performed. Note that the first time difference correction processing is the same processing as that of the first embodiment, and a description thereof will thus be omitted here.

When the time difference correction controller 23 determines NO at step S59, or when the first time difference correction processing at step S20 is ended, the controller 20 performs step S60 to determine whether or not the position of the crown 8 has been changed. When NO is determined at step S60, the processing is returned to step S52 and the processing is continued. Further, when the controller 20 determines YES at step S60, the controller 20 ends the processing of the first time difference correction mode.

### Effects of Second Embodiment

According to the second embodiment, the same effects as those of the first embodiment can be obtained, and further, the DST setting can be displayed by the seconds hand 6 during the time difference correction, and thus, the time difference can be set while taking into consideration whether DST is ON or OFF. Thus, the user can set the time difference correctly, including the presence or absence of the daylight saving time setting.

Further, in the time difference correction mode in which the crown 8 is pulled out to the first stage, the DST can be switched by pressing the A button 9A. Thus, the time difference correction operation and the DST setting operation can be easily combined, and setting operability can be improved.

### Third Embodiment

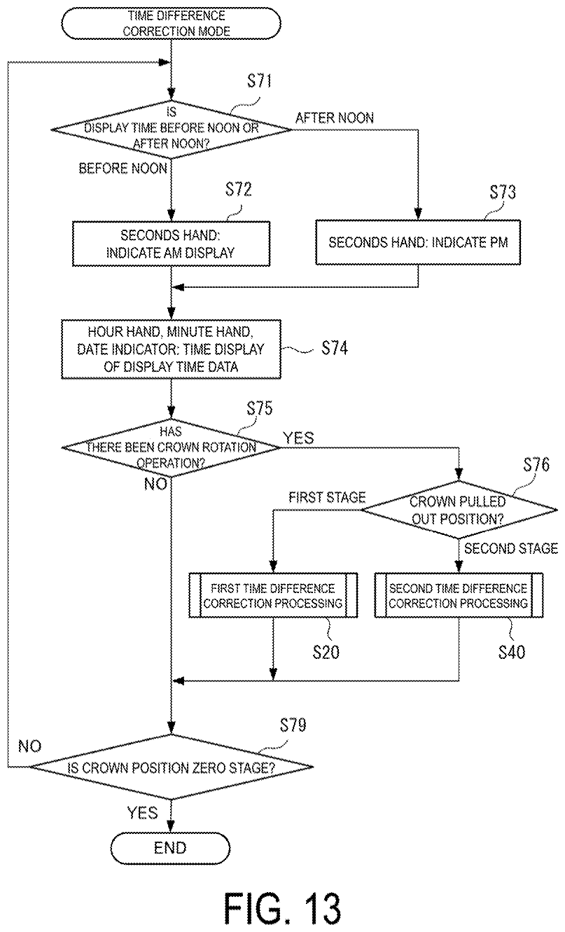

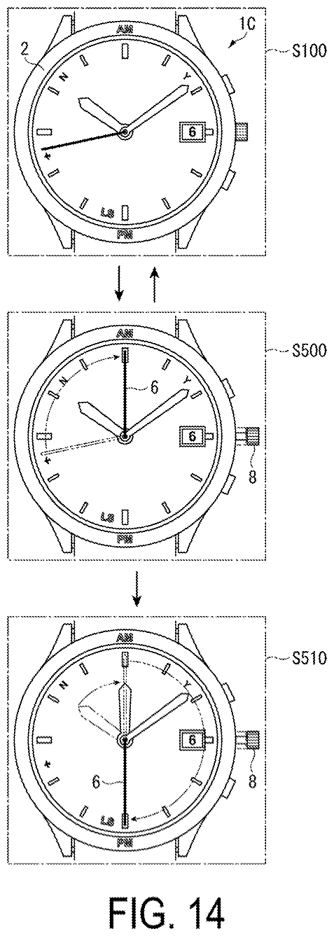

Next, an electronic watch 1C according to a third embodiment will be described using a flowchart in FIG. 13 and an operation explanatory diagram in FIG. 14. Note that the internal configuration of the electronic watch 1C is the same as that of the electronic watch 1 according to the first embodiment illustrated in FIG. 2, and a description thereof is thus omitted here.

As illustrated in FIG. 14, the marks on the dial 3 of the electronic watch 1C are the same as those of the electronic watch 1. On the other hand, the electronic watch 1C is inscribed with “AM” and “PM” marks, which are not inscribed on the electronic watch 1. In other words, on the case 2 of the electronic watch 1C, the mark “AM” is displayed at the 0 second position of the seconds hand 6, indicating that the displayed time is before noon, and the mark “PM” is displayed at the 30 second position of the seconds hand 6, indicating that the displayed time is after noon.

Time Difference Correction Mode

In the electronic watch 1C, when the user pulls the crown out to the first or the second stage during the normal hand operation illustrated in S100 in FIG. 14, the controller 20 performs step S71 in which the controller 20 starts the first time difference correction mode or the second time difference correction mode, and determines whether the current displayed time is before noon or after noon. Note that, since the reference time data 141 and the display time data 143 are recorded using a 24 hour clock, it is possible to determine whether the time is before noon or after noon by referring to the display time data 143.

When the controller 20 determines, at step S71, that the time is before noon, the controller 20 performs step S72 and indicates the display of “AM” by the seconds hand 6. When the step S72 is performed, the display time controller 25 moves and stops the seconds hand 6 at a position indicating the mark “AM” inscribed on the case 2, that is, the 0 second position, as illustrated in S500 in FIG. 14.

On the other hand, when the controller 20 determines, at step S71, that the time is after noon, the controller 20 performs step S73, and the display time control device 25 moves and stops the seconds hand 6 at the 30 second position at which “PM” is inscribed.

Next, the controller 20 performs step S74 and, apart from the seconds hand 6, continues to display the time of the display time data 143, that is, the current time, by the hour hand 4, the minute hand 5, and the date indicator 7.

After the processing at step S74 is performed, the time difference correction controller 23 of the controller 20 performs step S75 and, in a similar manner to the first embodiment, determines whether or not there has been the rotation operation of the crown 8.

When YES is determined at step S75, the time difference correction controller 23 performs step S76 and determines the pulled out position of the crown 8. When it is determined, at step S76, that the crown 8 is at the first stage, the time difference correction controller 23 performs the first time difference correction processing at step S20, and when it is determined that the crown 8 is at the second stage, the time difference correction controller 23 performs the second time difference correction processing at step S40. Note that the first time difference correction processing and the second time difference correction processing are the same as those of the first embodiment, respectively, and a description thereof will thus be omitted here.

Further, when the display time switches from one of before noon and after noon to the other while the time difference correction is being performed by the rotation operation of the crown 8, the indication of the seconds hand 6 also switches in conjunction, as illustrated in S510 in FIG. 14.

When the time difference correction controller 23 determines NO at step S75, when the first time difference correction processing at step S20 has ended, or when the second time difference correction processing at step S40 has ended, the controller 20 performs step S79 and determines whether or not the position of the crown 8 has been changed to the zero stage. When NO is determined at step S79, the controller 20 returns the processing to step S71 and continues the processing.

Further, when YES is determined at step S79, the controller 20 ends the processing of the time difference correction mode.

### Effects of Third Embodiment

According to the third embodiment, since it is possible to display whether it is before noon or after noon, using the seconds hand 6, during the time difference correction, it is possible to easily verify whether the display time that is displayed after the time difference correction performed by moving the hour hand 4 and the minute hand 5 by the rotation operation of the crown 8 is the time before noon or the time after noon. The time difference can thus be accurately set.

### Other Embodiments

Note that the present disclosure is not limited to the embodiments described above, and various modifications are possible within the scope of the present disclosure.

For example, in each of the embodiments described above, the time difference is corrected by the rotation operation of the crown 8, but the time difference may be corrected by a pressing operation of the A button 9A and the B button 9B.

Further, as in the third embodiment, when no switching operation of the settings is necessary, the electronic watch may have a simple design provided with the crown 8 only, and not provided with the A button 9A and the B button 9B. In other words, the operation device of the electronic watch may be provided with at least one of the crown 8 or a button.

The other information displayed by a third pointer of the electronic watch during the execution of the time difference correction mode is not limited to the airplane mode setting information, the daylight saving time setting information, and the information relating to before and after noon. In other words, information not directly relating to the time difference correction, such as the airplane mode setting information, the reception results, the battery residual capacity, and the like, may be displayed, or information relating to the time difference correction, such as version information of the time zone data stored in the time zone data storage unit 146, and the like, may be displayed.

Further, in each of the above-described embodiments, when the crown 8 is pulled out to the second stage, other information may be displayed, using the third pointer, that is different from when the crown 8 is pulled out to the first stage. For example, in the first embodiment, the daylight saving time setting information and the information relating to before or after noon may be displayed when the crown 8 is pulled out to the second stage, Further, in the second and third embodiments, the airplane mode setting information may be displayed when the crown 8 is pulled out to the second stage. As described above, a combination of the information displayed using the third pointer when the crown 8 is pulled out to the first stage, and the information displayed using the third pointer when the crown 8 is pulled out to the second stage may be set as appropriate, in accordance with functions incorporated into the electronic watch.

The electronic watch is not limited to the simple watch with three hands, and may be a watch provided with a plurality of other pointers, such as a sub-dial, a sub-pointer, and the like. In this case also, the third pointer that is coaxial with the hour hand and the minute hand can be used to display various types of information, such as the airplane mode or daylight saving time settings, before noon/after noon, and the like, during the time difference correction mode, and thus the type of information that can be notified to the user can be increased and convenience can be improved.

In the time difference correction mode, the third pointer that causes other information different from the reference time and the time difference information to be displayed is not limited to the seconds hand 6, and may be a pointer for a chronograph or the like. In other words, in the electronic watch including a chronographic function, the first pointer shaft, the second pointer shaft, and the third pointer shaft disposed coaxially at the planar center of the dial may be provided with the hour hand, the minute hand, and a chronographic seconds hand, respectively. In this case, the chronographic seconds hand may function as the third pointer, and may display the other information during the time difference correction mode. In this case, the time display unit is configured by the hour hand and the minute hand.

Further, the electronic watch may be an electronic watch that is not provided with the date indicator and in which no date is displayed. In this case, the current date may be displayed using the seconds hand during the execution of the time difference correction mode.

A setting amount of the time difference set in the first time difference correction mode and the second time difference correction mode performed in accordance with the pulled-out position of the crown 8 is not limited to the examples of each of the embodiments described above. For example, if the time zone is changed and it is no longer necessary to set the time difference in units of 15 minutes, in the second time difference correction mode, the time difference may be corrected in units of 30 minutes.

The radio waves received by the receiver are not limited to the satellite signals, and other radio waves, such as Bluetooth (registered trademark), bluetooth low energy (BLE), Wi-Fi (registered trademark), near field communication (NFC), low power wide area (LPWA), and the like, may be received.

Further, in each of the embodiments described above, the electronic watch is described in which radio waves are received from a GPS satellite or the like and the positional information can be acquired. However, the electronic watch need not necessarily include the function of acquiring the positional information. Further, the electronic watch need not necessarily be provided with the receiver and the timekeeping reception cotroller, and the positioning reception cotroller, and may be an electronic watch in which the time difference can only be manually corrected.

What is claimed is:

1. An electronic watch comprising:
a storage unit configured to store time difference information, with the information relating to a time difference with respect to a reference time;
a time display unit including a first pointer fixed to a first pointer shaft and a second pointer fixed to a second pointer shaft coaxial with the first pointer shaft, the time display unit being configured to display a display time based on the reference time and the time difference information;
a third pointer fixed to a third pointer shaft coaxial with the first pointer shaft and the second pointer shaft;
an operation device including a crown or a button; and
a controller configured to, in accordance with an operation of the operation device, execute a time difference correction mode that corrects the time difference information and causes the first pointer and the second pointer to display the display time in accordance with the corrected time difference information, wherein
the first pointer is an hour hand and the second pointer is a minute hand, and
in the time difference correction mode, the controller causes the third pointer to display other information different from the reference time and the time difference information.

2. The electronic watch according to claim 1, comprising a receiver configured to receive radio waves, wherein
the controller is configured to set a reception prohibiting mode that prohibits reception by the receiver, and
the other information is information indicating the setting of the reception prohibiting mode.

3. The electronic watch according to claim 1, wherein
the storage unit stores daylight saving time information relating to setting of a daylight saving time,
the time display unit displays the display time based on the daylight saving time information, and
the other information is the daylight saving time information.

4. The electronic watch according to claim 1, wherein
the other information is information relating to whether the display time in accordance with the corrected time difference information is before noon and after noon.

5. The electronic watch according to claim 1, wherein
when the time difference information is corrected in accordance with the operation of the operation device, the controller moves the first pointer and the second pointer to positions indicating the display time calculated based on the corrected time difference information and the reference time.

6. The electronic watch according to claim 1, wherein
the third pointer is a seconds hand.

7. The electronic watch according to claim 1, wherein
the operation device includes the crown configured to be pulled out to a plurality of stages,
the controller executes the time difference correction mode when the crown is pulled out to a first stage and when the crown is pulled out to a second stage, and
the third pointer displays different information when the crown is pulled out to the first stage from information displayed when the crown is pulled out to the second stage.

8. The electronic watch according to claim 1, wherein
the controller corrects the time difference information in increments of a fixed time period, in accordance with the operation of the operation device.
